(19) United States
(12) Patent Application Publication
(10) Pub. No.: US 2002/0124802 A1
(43) Pub. Date: Sep. 12, 2002

(54) Construction for automatically milking animals

(75) Inventors: Alexander van der Lely, Rotterdam (NL); Karel van den Berg, Bleskensgraaf (NL); Renatus Ignatius Josephus Fransen, Vlaardingen (NL)

Correspondence Address: Penrose Lucas Albright, Esq., MASON, MASON & ALBRIGHT, P.O. Box 2246, Arlington, VA, 22202-0246, US

(73) Assignee: LELY RESEARCH HOLDING A.G.

(21) Appl. No.: 09/901,066

(22) Filed: Jul. 10, 2001

(30) Foreign Application Priority Data
Oct. 7, 2000 (NL) 1015671

(51) Int. Cl. A01J 3/00; A01J 5/00

(52) U.S. Cl. 119/14.1

(57) ABSTRACT

An apparatus for automatically milking animals, such as cows, which comprises a milking compartment with a milking robot provided with a robot arm for connecting teat cups to the teats of an animal to be milked in the milking compartment. The teat cups are movable to immediately under and away from the udder of the animal being milked in the milking compartment by the robot arm. At the front of the milking compartment a feeding trough is pivotably connected to the milking compartment so that it is movable between a first position beyond the reach of an animal to be milked in the milking compartment and a second position within the reach of such animal. Linkage is provided by a single piston and cylinder member to couple movements of the feeding trough with movements of the robot arm so that a clear relationship is provided between feeding and milking an animal to be milked in the milking compartment and the mechanism for doing so is direct and efficient.

### FIELD OF THE INVENTION

The invention relates to an apparatus for automatically milking animals in a milking compartment which includes a robot arm for moving teat cups under the udder of the animal to be milked and therefrom so as not to obstruct the animal from entering and leaving the milking compartment. The milking compartment also includes a feeding trough to provide the animal with fodder or water or both while being milked.

### BACKGROUND OF THE INVENTION

Milking stalls having feeding troughs that can be pivoted away are known. For example, EPO 647390 A2, published Apr. 12, 1995, of Cornelis van der Lely, discloses a feeding trough that can be swiveled from the milking compartment. A manger is shown in a milking parlor which can be moved outside of guide rails whereby a cow disposed between the rails can move forward, in EPO 320496, of Ary van der Lely, published Jun. 14, 1989. Feed troughs that are movable at the end of the milking process are disclosed in International Patent Application PCT/NL93/00012, filed Jan. 13, 1993, WO 93/13651, published Jul. 22, 1993 of Oosterling et al.

### SUMMARY OF THE INVENTION

The invention aims further to develop and improve known apparatuses. According to the invention this is achieved by providing for the coupling of the means for moving the teat cups and for moving the feeding trough. In this manner a clear relationship between feeding and milking of the animals to be milked is obtained. Moreover, the disclosed construction is very efficient.

### BRIEF DESCRIPTION OF THE DRAWINGS:

The invention will now be explained in further detail with reference to the accompanying figures.

FIG. 1 is a schematic plan view of the apparatus according to the invention; and

FIG. 2 is a schematic side elevational view of a detail of the apparatus according to the arrow II in FIG. 1.

### DETAILED DESCRIPTON OF THE PREFERRED EMBODIMENTS

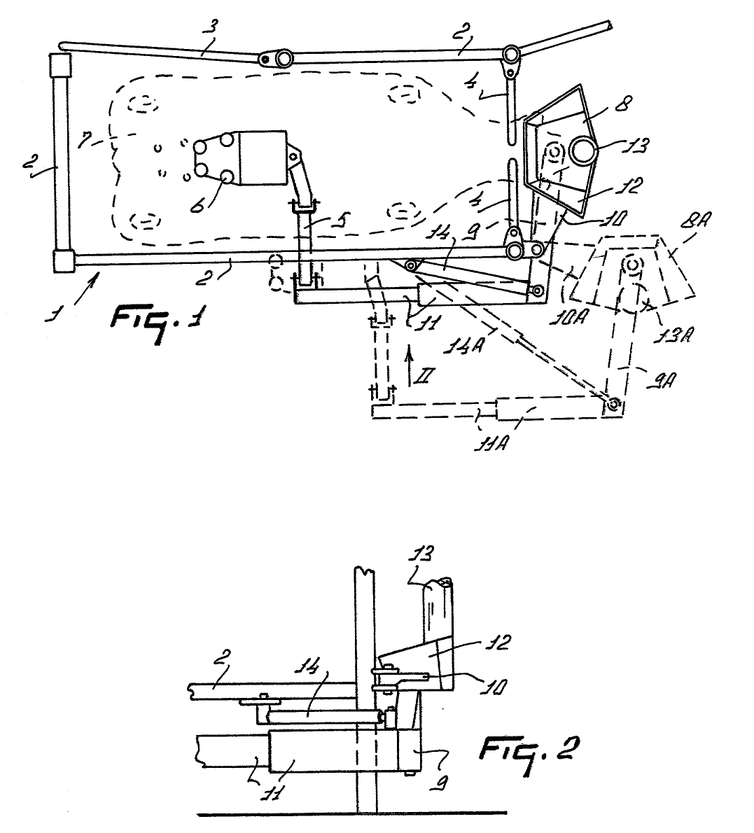

FIG. 1 is a schematic plan view of an apparatus according to the invention which comprises a milking compartment 1, provided with a framework 2 having an entrance gate 3 and an exit gate 4. A milking robot is provided with a robot arm 5 that is controllable in three dimensions for connecting teat cups 6 to the teats of an animal 7 to be milked (schematically indicated by dashed lines). The milking robot is further provided with milk lines, animal identification means and control equipment, all of which are well known to those skilled in the art. Teat cups 6 are movable to just under the udder of animal 7 to be milked, and away therefrom with the aid of robot arm 5.

At the front of the milking compartment 1, near exit gate 4, is a feeding trough 8 for providing feed or water or both to animal 7. Said feeding trough 8 is movable between a first position beyond the reach of animal 7 and a second position within the reach of animal 7.

According to the invention, a means is provided for coupling movement of feeding trough 8 to movement of robot arm 5. In the embodiment shown, this means comprises a fixed connecting arm 9 between robot arm 5 and feeding trough 8. Of course, other types of connections will occur to those skilled in the art. Feeding trough 8 is pivotable relative to milking compartment 1 by means of a pivotable arm 10.

Connecting arm 9 (see also the side view of FIG. 2) is at one side fixedly connected with a telescoping part 11 of robot arm 5, by means of which teat cups 6 can be moved in the longitudinal direction of milking compartment 1. At its other side, connecting arm 9 is rotatably connected with a base 12 of feeding trough 8. Feeding trough 8 is connected a tube 13. Pivotable arm 10 is at one side rotatably connected with milking compartment 1 and is at its other side is fixedly connected with base 12 of feeding trough 8. There is further provided a piston and cylinder member 14 which is at one end rotatably fastened to milking compartment 1 and is at its other end rotatably fastened to connecting arm 9, approximately in the region where the latter is connected with telescoping part 11.

The apparatus provides coordinated movements of feeding trough 8 and robot arm 5 both towards and away from the animal 7 by means of a single control element, piston and cylinder member 14. This is illustrated by means of the elements 8A, 9A, 10A, 11A, 13A and 14A, which are indicated by dashed lines in FIG. 1 to correspond to the pivoted-away position of robot arm 5, feeding trough 8, connecting arm 9, telescoping part 11, tube 13 and piston and cylinder member 14. Piston and cylinder member 14 is then in an extended position wherein it is designated by reference numeral 14A.

Control means comprising connecting arm 9 and piston and cylinder member 14 are suitable for simultaneously executing the movements of feeding trough 8 and robot arm 5 together with telescoping part 11 away from animal 7. Movements of feeding trough 8, robot arm 5, and telescoping part 11 towards animal 7 occur simultaneously as well.

A further embodiment may be provided for causing movements of feeding trough 8 and the robot arm 5 away from animal 7 or towards animal 7 to occur with an interval wherein the particular interval may be adjustable.

Although we have disclosed the preferred embodiments of our invention, it is to be understood that it is capable of other adaptations and modifications within the scope of the following claims.

11. An apparatus for the automated milking of animals which comprises: a milking compartment for receiving an animal to be milked; teat cups; a feeding trough which is received in said milking compartment for feeding an animal therein that is being milked; a robot arm which is received in said milking compartment, said teat cups being carried by said robot arm for milking an animal in said milking compartment; first control means for moving said robot arm between a position wherein said teat cups are connected to the teats of an animal in said milking compartment and a position wherein said robot arm is beyond the reach of an animal in said milking compartment; second control means for moving said feeding trough between a position within the reach of an animal in said milking compartment and a position wherein said feeding trough is beyond the reach of an animal in said milking compartment; and linkage means that couples said robot arm to said trough whereby said robot arm and said trough are moved substantially simultaneously by said first control means and said second control means between positions which are within the reach of an animal in said milking compartment and positions which are beyond the reach of an animal in said milking compartment;

12. An apparatus in accordance with claim 11, wherein said linkage means comprises a piston and cylinder member.

13. An apparatus in accordance with claim 11, wherein said second control means pivots said trough relative to said milking compartment.

14. An apparatus in accordance with claim 11, wherein said linkage means comprises a telescoping part.

15. An apparatus in accordance with claim 11, wherein said linkage means comprises a connecting arm which interconnects said feeding trough and said robot arm.

16. An apparatus in accordance with claim 11, wherein said linkage means comprises a single piston and cylinder member.

17. An apparatus in accordance with claim 16, wherein said linkage means or comprises a connecting arm and a single piston and cylinder member which is connected on one end to said milking compartment and on the other end to said connecting arm.

18. An apparatus for automatically milking animals which comprises a milking compartment, a milking robot, said milking robot being provided with a controllable robot arm for connecting teat cups to the teats of an animal to be milked, said teat cups being movable by said robot arm to immediately under the udder of an animal in said milking compartment to be milked and also being movable away therefrom by said robot arm, a feeding trough for providing a consumable substance to an animal to be milked in said milking compartment, said feeding trough being disposed pivotally on said milking compartment at its forward aspect, said feeding trough being movable between a first position beyond the reach of an animal to be milked in said milking compartment and a second position within the reach of an animal to be milked in said milking compartment, and linkage means being provided for coupling the movement of said feeding trough to the movement of said robot arm.

19. An apparatus in accordance with claim 18, wherein said linkage means provides that said coupled movements of said feeding trough and said robot arm occur substantially simultaneously.

20. An apparatus in accordance with claim 18, wherein said linkage means comprises a connecting arm that connects said feeding trough with said robot arm.

21. An apparatus in accordance with claim 18, which comprises a pivotable arm which pivotably connects said feeding trough to said milking compartment so that said feeding trough is pivotable relative to said milking compartment by means of said pivotable arm.

22. An apparatus in accordance with claim 18, wherein said linkage means comprises a single piston and cylinder member.

23. An apparatus in accordance with claim 22, which comprises a connecting arm which is connected to said feeding trough, said piston and cylinder member being fastened on one end to said milking compartment and on its other end being fastened to said connecting arm.

24. An apparatus in accordance with claim 23, wherein said robot arm comprises a telescoping part.
